(19) United States
(12) Patent Application Publication
(10) Pub. No.: US 2025/0198873 A1
(43) Pub. Date: Jun. 19, 2025

(54) LEAKAGE DETECTION APPARATUS, LEAKAGE DETECTION METHOD, AND NON-TRANSITORY COMPUTER-READABLE MEDIUM

(71) Applicant: NEC Corporation, Minato-ku (JP)

(72) Inventors: Kazunobu KAWAHARAGI, Tokyo (JP); Koji MIZUGUCHI, Tokyo (JP); Naoki NISHIMURA, Tokyo (JP)

(73) Assignee: NEC Corporation, Minato-ku (JP)

(21) Appl. No.: 18/971,181

(22) Filed: Dec. 6, 2024

(30) Foreign Application Priority Data
Dec. 18, 2023 (JP) 2023-213352

(51) Int. Cl. G01M 3/04; G01D 5/353

(52) U.S. Cl. CPC G01M 3/047; G01D 5/35358

(57) ABSTRACT

A leakage detection apparatus according to the present disclosure includes: at least one memory storing instructions; and at least one processor configured to execute the instructions to transmit pulsed light to an optical fiber laid in a pipe through which a fluid flows and receive backscattered light from the optical fiber, generate sound data indicating a state of the fluid flowing through the pipe, based on the backscattered light, and detect leakage of the fluid by analyzing the sound data.

### INCORPORATION BY REFERENCE

This application is based upon and claims the benefit of priority from Japanese patent application No. 2023-213352, filed on Dec. 18, 2023, the disclosure of which is incorporated herein in its entirety by reference.

### TECHNICAL FIELD

The present disclosure relates to a leakage detection apparatus, a leakage detection method, and a non-transitory computer-readable medium.

### BACKGROUND ART

In recent years, a technique for monitoring a state of a pipe, for example, presence or absence of leakage of a fluid flowing through the pipe, has been proposed (for example, Japanese Unexamined Patent Application Publication No. 2016-057241).

According to the technique disclosed in Japanese Unexamined Patent Application Publication No. 2016-057241, a sensor such as a piezoelectric acceleration sensor, an electrokinetic acceleration sensor, a capacitive acceleration sensor, an optical speed sensor, or a dynamic strain sensor is installed in order to detect vibration of a pipe. Then, an analysis unit analyzes the state of the pipe, based on a detection result of the vibration of the pipe.

### SUMMARY

However, in the technique disclosed in Japanese Unexamined Patent Application Publication No. 2016-057241, a dedicated sensor for detecting vibration of a pipe is required. Therefore, a technique capable of detecting leakage of a fluid flowing through the pipe without providing a dedicated sensor for detecting vibration of the pipe is desired.

In view of the problem described above, an example object of the present disclosure is to provide a leakage detection apparatus, a leakage detection method, and a non-transitory computer-readable medium that make it possible to detect leakage of a fluid flowing through a pipe without providing a dedicated sensor for detecting vibration of the pipe.

In a first example aspect, a leakage detection apparatus includes:
at least one memory storing instructions; and
at least one processor configured to execute the instructions to
   transmit pulsed light to an optical fiber laid in a pipe through which a fluid flows, and receive backscattered light from the optical fiber,
   generate sound data indicating a state of the fluid flowing through the pipe, based on the backscattered light, and
   detect leakage of the fluid by analyzing the sound data.

In a second example aspect, a leakage detection method is a leakage detection method to be performed by a leakage detection apparatus, and includes:
transmitting pulsed light to an optical fiber laid in a pipe through which a fluid flows, and receiving backscattered light from the optical fiber;
generating sound data indicating a state of the fluid flowing through the pipe, based on the backscattered light; and
detecting leakage of the fluid by analyzing the sound data.

In a third example aspect, a non-transitory computer-readable medium is a non-transitory computer-readable medium storing a program causing a computer to execute:
a procedure of transmitting pulsed light to an optical fiber laid in a pipe through which a fluid flows, and receiving backscattered light from the optical fiber;
a procedure of generating sound data indicating a state of the fluid flowing through the pipe, based on the backscattered light; and
a procedure of detecting leakage of the fluid by analyzing the sound data.

An example advantage according to the above-described aspects is that it is possible to provide a leakage detection apparatus, a leakage detection method, and a non-transitory computer-readable medium that make it possible to detect leakage of a fluid flowing through a pipe without providing a dedicated sensor for detecting vibration of the pipe.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a configuration example of a leakage detection system according to the present disclosure;

FIG. 2 is a flow diagram illustrating an operation example of the leakage detection system according to the present disclosure;

FIG. 3 is a diagram illustrating a laying example of an optical fiber;

FIG. 4 is a diagram illustrating a configuration example of a pipe;

FIG. 5 is a diagram illustrating an example of sound data;

FIG. 6 is a diagram illustrating an example in which FFT is performed on sound data;

FIG. 7 is a diagram illustrating an example of a temporal shift of an anomaly score rate calculated in a first verification;

FIG. 8 is a diagram illustrating an example of a temporal shift of an anomaly score rate calculated in a second verification;

FIG. 9 is a diagram illustrating an example of a temporal shift of an anomaly score rate calculated in a third verification;

FIG. 10 is a diagram illustrating an example of a temporal shift of an anomaly score rate calculated in a fourth verification;

FIG. 11 is a diagram illustrating a configuration example of a leakage detection system according to the present disclosure; and

FIG. 12 is a block diagram illustrating a hardware configuration example of a computer that achieves the leakage detection apparatus according to the present disclosure.

### EXAMPLE EMBODIMENT

Hereinafter, example embodiments of the present disclosure are described with reference to the drawings. Note that the following description and the drawings are omitted and simplified as appropriate for clarity of description. In the following drawings, the same elements are denoted by the same reference numerals, and redundant descriptions are omitted as necessary. Further, specific numerical values and the like described below are merely examples for facilitating understanding of the present disclosure, and are not limited thereto.

### First Example Embodiment

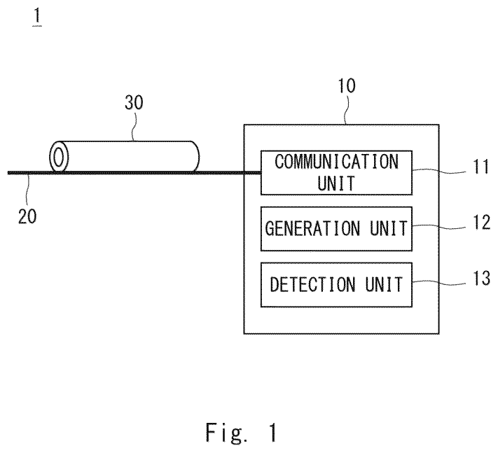

First, a configuration example of a leakage detection system 1 is described with reference to FIG. 1.

The leakage detection system 1 includes a leakage detection apparatus 10.

The leakage detection apparatus 10 includes a communication unit 11, a generation unit 12, and a detection unit 13. For example, the functions of the communication unit 11 and the generation unit 12 can be implemented by a sensing apparatus such as a distributed fiber optic sensing (DFOS) apparatus.

An optical fiber 20 is connected to the communication unit 11.

The optical fiber 20 is laid in a pipe 30 through which a fluid flows, along the longitudinal direction of the pipe 30. In the example of FIG. 1, the optical fiber 20 is laid on the outer periphery of the pipe 30, but the laying method for the optical fiber 20 is not limited thereto.

The pipe 30 may be any pipe as long as it is a pipe through which a fluid flows.

The fluid flowing through the pipe 30 may be any of a liquid, a gas, and a solid.

Further, the laying location of the pipe 30 may be any location, such as on the ground, in the ground, a ceiling, a floor, or a wall.

The communication unit 11 transmits pulsed light to the optical fiber 20. Then, as the pulsed light is transmitted through the optical fiber 20, backscattered light is generated. The communication unit 11 receives the generated backscattered light from the optical fiber 20.

Herein, in a case where the fluid flows through the pipe 30, a sound is generated. In a case where a state of the fluid flowing through the pipe 30 changes, the sound changes by being affected by such a change. The change in the sound is transmitted to the optical fiber 20. As a result, characteristics (e.g., wavelength) of the backscattered light transmitted through the optical fiber 20 change.

Therefore, the generation unit 12 is able to generate sound data indicating the state of the fluid flowing through the pipe 30, based on the backscattered light received by the communication unit 11. Such sound data are data of a sound generated at a position where the backscattered light is generated on the optical fiber 20, specifically, data indicating a temporal shift in acoustic intensity of such sound.

As described above, the sound data generated by the generation unit 12 are data indicating the state of the fluid flowing through the pipe 30. Therefore, by analyzing the above-described sound data, the detection unit 13 is able to determine whether the state of the fluid flowing through the pipe 30 has changed. Specifically, the detection unit 13 is able to determine whether the fluid flowing through the pipe 30 has leaked.

Therefore, the detection unit 13 detects the leakage of the fluid flowing through the pipe 30 by the analysis of the sound data described above.

Herein, in the analysis of the sound data described above, the detection unit 13 may calculate an anomaly score rate associated with a deviation amount between a frequency component of the sound data and a frequency component of sound data at a normal state, and detect the leakage of the fluid flowing through the pipe 30, based on the temporal shift of the anomaly score rate. Details of the anomaly score rate are described later.

Further, the detection unit 13 may hold a learning model which is trained, in advance, with an association relationship between the temporal shift of the anomaly score rate and the presence or absence of the leakage of the fluid flowing through the pipe 30. Then, the detection unit 13 may detect the leakage of the fluid flowing through the pipe 30, based on the temporal shift of the anomaly score rate and the learning model described above.

Further, in a case where the leakage of the fluid flowing through the pipe 30 is detected by the analysis of the sound data described above, the detection unit 13 may determine the position where the leakage has occurred.

Herein, the position where the leakage has occurred is equivalent to the position where the backscattered light being the source of the above-described sound data is generated. For example, the detection unit 13 calculates a time difference between the time when the pulsed light is transmitted to the optical fiber 20 by the communication unit 11 and the time when the backscattered light is received from the optical fiber 20 by the communication unit 11. Based on the calculated time difference, the detection unit 13 is able to determine the position (the distance of the optical fiber 20 from the communication unit 11) where the backscattered light is generated.

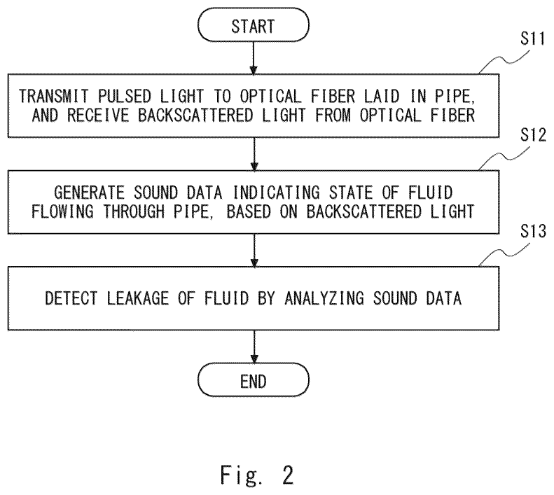

Next, an operation example of the leakage detection system 1 is described with reference to FIG. 2.

First, the communication unit 11 transmits pulsed light to the optical fiber 20 and receives backscattered light from the optical fiber 20 (step S11).

Next, the generation unit 12 generates sound data indicating the state of the fluid flowing through the pipe 30, based on the backscattered light received by the communication unit 11 (step S12).

Thereafter, the detection unit 13 detects leakage of the fluid flowing through the pipe 30 by analyzing the sound data generated by the generation unit 12 (step S13).

As described above, according to the first example embodiment, the communication unit 11 transmits pulsed light to the optical fiber 20 and receives backscattered light from the optical fiber 20. The generation unit 12 generates sound data indicating the state of the fluid flowing through the pipe 30, based on the backscattered light. The detection unit 13 detects leakage of the fluid flowing through the pipe 30 by analyzing the sound data. Thus, it is possible to detect the leakage of the fluid flowing through the pipe 30, without providing a dedicated sensor for detecting vibration of the pipe 30 as disclosed in Japanese Unexamined Patent Application Publication No. 2016-057241.

### Verification of First Example Embodiment

Next, a result of a verification experiment performed in relation to the first example embodiment is described below.

First, preconditions of the present verification experiment are described.

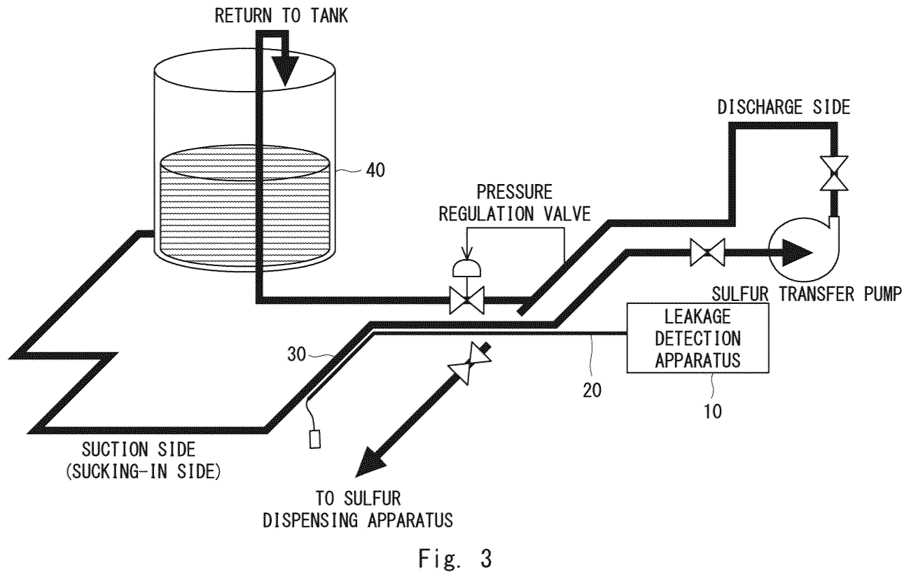

First, a laying example of an optical fiber 20 being used in the present verification experiment is described with reference to FIG. 3.

The optical fiber 20 is laid in a pipe 30 configured to supply liquid sulfur stored in a sulfur storage tank 40 to a sulfur dispensing apparatus (not illustrated). Note that, in the example of FIG. 3, the optical fiber 20 is laid in the pipe 30 on a suction side for sucking in liquid sulfur from the sulfur storage tank 40, but is not limited thereto. The optical fiber 20 may be laid in the pipe 30 on a discharge side for discharging the liquid sulfur to the sulfur dispensing apparatus.

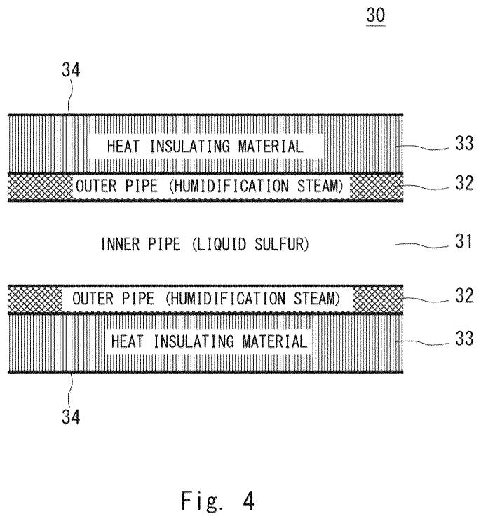

Next, a configuration example of the pipe 30 being used in the present verification experiment is described with reference to FIG. 4. The pipe 30 is a jacketed pipe (double pipe) including an inner pipe 31 through which liquid sulfur flows, and an outer pipe 32 configured to cover the inner pipe 31 with a gap interposed therebetween and cause humidification steam to flow through the gap.

The pipe 30 further includes a heat insulating material 33 configured to cover the outer pipe 32, and an exterior plate 34 configured to cover the heat insulating material 33. The heat insulating material 33 is formed of, for example, calcium silicate. The exterior plate 34 is formed of, for example, a galvanized steel plate.

In the present verification experiment, under the precondition that the optical fiber 20 is laid on the above-described pipe 30 by the above-described laying method, first to fourth verifications described later are performed. In each of the first to four verifications, anomaly score rate is calculated from sound data of sound generated at a specific position on the optical fiber 20, and a temporal shift in the anomaly score rate is confirmed.

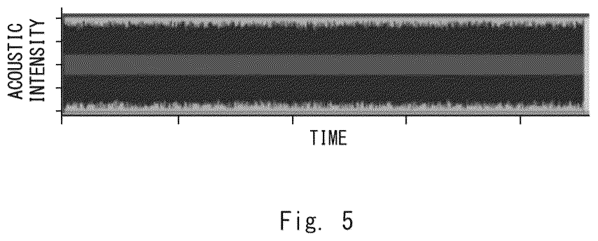

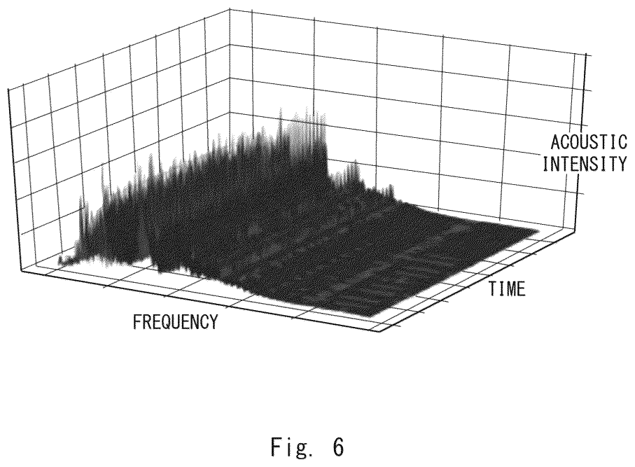

First, a method for calculating an anomaly score rate is described with reference to FIG. 5 and FIG. 6.

FIG. 5 illustrates an example of sound data. The sound data are data indicating a temporal shift in acoustic intensity of a sound generated at a specific position on the optical fiber 20.

FIG. 6 illustrates an example in which fast Fourier transform (FFT) is performed on the sound data as illustrated in FIG. 5.

By performing FFT on the sound data, the sound data are divided into frequency components. Each frequency component of the sound data is compared with each frequency component of sound data at a normal state, and a deviation amount between the frequency components (that is, a difference in the shape of frequency distribution between the frequency components) is acquired. An anomaly score rate is calculated in accordance with the deviation amount. That is, the anomaly score rate is calculated in such a way that the larger the deviation amount between the frequency components is, the higher the rate is.

Next, each of the first to fourth verifications is described.

### First Verification

In the first verification, liquid sulfur is not flown through the inner pipe 31 of the pipe 30, and a small amount of humidification steam is flown through the outer pipe 32 of the pipe 30.

The state of the first verification is equivalent to a normal state during which the sulfur dispensing apparatus (not illustrated) is not performing a sulfur dispensing operation.

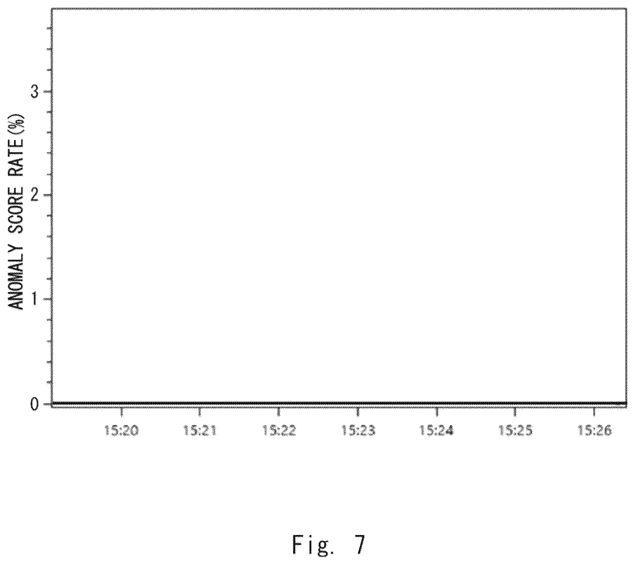

FIG. 7 illustrates an example of a temporal shift of an anomaly score rate calculated in the first verification.

### Second Verification

In the second verification, the liquid sulfur is flown through the inner pipe 31 of the pipe 30, and a small amount of the humidification steam is flown through the outer pipe 32 of the pipe 30.

The state of the second verification is equivalent to a normal state during which the sulfur dispensing apparatus (not illustrated) is performing the sulfur dispensing operation.

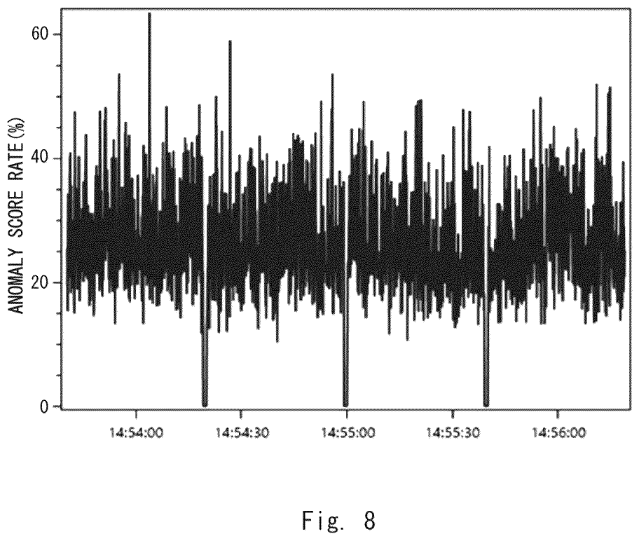

FIG. 8 illustrates an example of a temporal shift of an anomaly score rate calculated in the second verification.

Comparing FIG. 7 and FIG. 8, it can be seen that in a case where the sulfur dispensing operation is performed, the waveform of the temporal shift of the anomaly score rate changes. Therefore, it can be seen from the waveform of the temporal shift of the anomaly score rate in FIG. 8 that the sulfur dispensing operation is being performed.

### Third Verification

In the third verification, the liquid sulfur is not flown through the inner pipe 31 of the pipe 30, and the humidification steam is continuously flown through the outer pipe 32 of the pipe 30 at a flow rate higher than that in the first verification.

The state of the third verification is equivalent to a state where the humidification steam is leaking from the outer pipe 32 to the inner pipe 31 during which the sulfur dispensing apparatus (not illustrated) is not performing the sulfur dispensing operation.

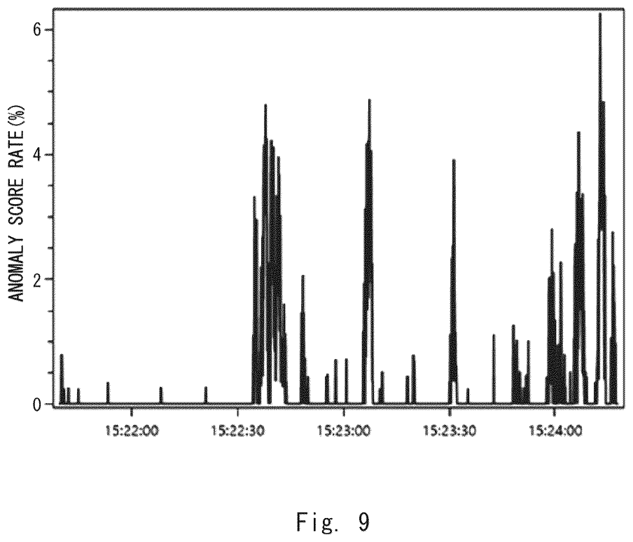

FIG. 9 illustrates an example of a temporal shift of an anomaly score rate calculated in the third verification.

Comparing FIG. 7 and FIG. 9, it can be seen that in a case where the humidification steam is leaking from the outer pipe 32 to the inner pipe 31, the waveform of the temporal shift of the anomaly score rate changes. Therefore, it can be seen from the waveform of the temporal shift of the anomaly score rate in FIG. 9 that the humidification steam is leaking from the outer pipe 32 to the inner pipe 31.

### Fourth Verification

In the fourth verification, the liquid sulfur is flown through the inner pipe 31 of the pipe 30, and the humidification steam is intermittently flown through the outer pipe 32 of the pipe 30 at a flow rate higher than that in the first verification.

The state of the fourth verification is equivalent to a state where the liquid sulfur is leaking from the inner pipe 31 to the outer pipe 32 during which the sulfur dispensing apparatus (not illustrated) is performing the sulfur dispensing operation.

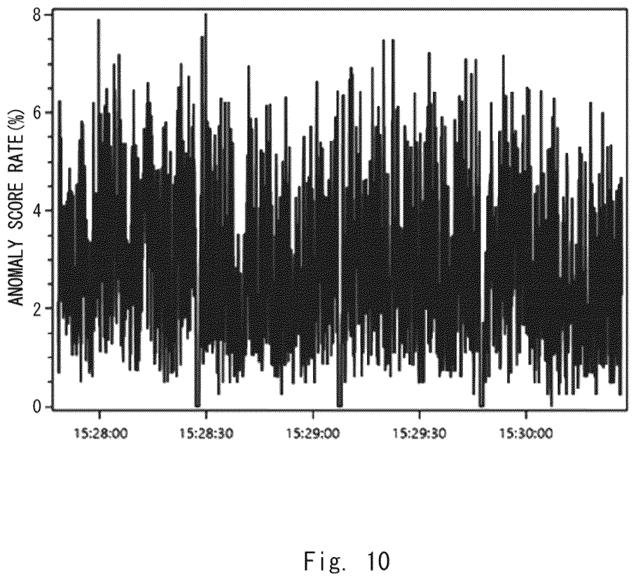

FIG. 10 illustrates an example of a temporal shift of an anomaly score rate calculated in the fourth verification.

Comparing FIG. 8 and FIG. 10, it can be seen that in a case where the liquid sulfur is leaking from the inner pipe 31 to the outer pipe 32, the waveform of the temporal shift of the anomaly score rate changes. Therefore, it can be seen from the waveform of the temporal shift of the anomaly score rate in FIG. 10 that the liquid sulfur is leaking from the inner pipe 31 to the outer pipe 32.

As described above, the leakage of the liquid sulfur or the humidification steam flowing through the pipe 30 can be detected from the temporal shift of the anomaly score rate.

Therefore, in the first example embodiment, the generation unit 12 generates sound data of sound generated at a specific position on the optical fiber 20, the detection unit 13 calculates an anomaly score rate from the sound data, and detects the leakage of the liquid sulfur or the humidification steam at the specific position, based on the temporal shift of the anomaly score rate. Specifically, the detection unit 13 detects the leakage of the liquid sulfur from the inner pipe 31 to the outer pipe 32, and also detects the leakage of the humidification steam from the outer pipe 32 to the inner pipe 31.

Note that, in order to improve the accuracy of the leakage detection, the detection unit 13 may hold a learning model which is trained, in advance, with an association relationship between the temporal shift of the anomaly score rate and the presence or absence of the leakage of the liquid sulfur or the humidification steam. In such a case, the learning model is trained in advance with, for example, an association relationship between the waveform of the temporal shift of the anomaly score rate in FIG. 9 and the result that the leakage of the humidification steam from the outer pipe 32 to the inner pipe 31 is “present”. Further, the learning model is trained in advance with an association relationship between the waveform of the temporal shift of the anomaly score rate in FIG. 10 and the result that the leakage of the liquid sulfur from the inner pipe 31 to the outer pipe 32 is “present” The learning model is, for example, a model that outputs a determination result of the presence or absence of the leakage, upon input of the waveform of the temporal shift of the anomaly score rate. Then, the detection unit 13 may detect the leakage of the liquid sulfur or the humidification steam, based on the temporal shift of the anomaly score rate and the learning model described above.

Further, in order to improve the accuracy of the leakage detection by the detection unit 13, it is necessary to collect sound generated in the inner pipe 31 and the outer pipe 32 more accurately in accordance with the presence or absence of a leakage. Therefore, it is suitable for the optical fiber 20 to be laid near the inner pipe 31 and the outer pipe 32. Therefore, in a case where the pipe 30 has the configuration as illustrated in FIG. 4, the optical fiber 20 may be laid between the heat insulating material 33 and the exterior plate 34.

### Other Example Embodiments

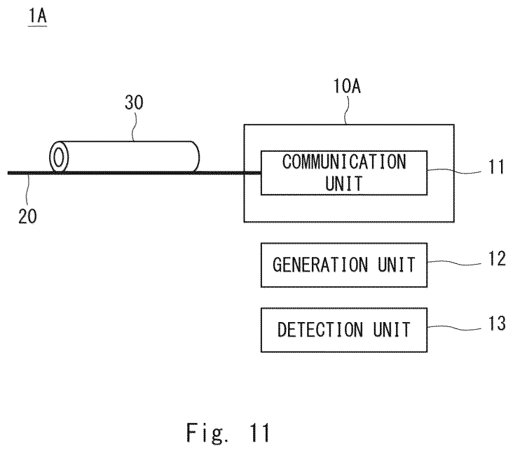

In the first example embodiment described above, the communication unit 11, the generation unit 12, and the detection unit 13 are provided inside the leakage detection apparatus 10, but the present disclosure is not limited thereto. The communication unit 11, the generation unit 12, and the detection unit 13 may be separately provided in different apparatuses, or the generation unit 12 and the detection unit 13 may be provided in the cloud. FIG. 11 illustrates a configuration example of a leakage detection system 1A wherein a generation unit 12 and a detection unit 13 are provided on a different apparatus separately from a leakage detection apparatus 10A in which with the communication unit 11 is provided, or the generation unit 12 and the detection unit 13 are provided in the cloud.

### Hardware Configuration of Leakage Detection Apparatus According to Example Embodiments

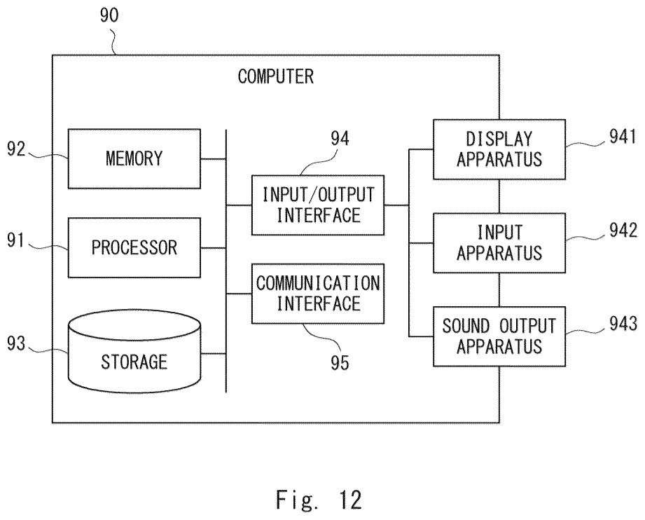

Next, a hardware configuration example of a computer 90 configured to implement the above-described leakage detection apparatus 10 is described with reference to FIG. 12.

As illustrated in FIG. 12, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for transmitting and receiving data to and from one another.

The processor 91 is, for example, an arithmetic processing apparatus such as a central processing unit (CPU) or a graphics processing unit (GPU). The memory 92 is, for example, a memory such as a random access memory (RAM) or a read only memory (ROM). The storage 93 is, for example, a storage apparatus such as a hard disk drive (HDD), a solid state drive (SSD), or a memory card. The storage 93 may be a memory such as a RAM or a ROM.

A program is stored in the storage 93. The program includes instructions (or software code) that, in a case where loaded into a computer, cause the computer 90 to perform one or more functions of the leakage detection apparatus 10 described above. The above-described constituent elements of the leakage detection apparatus 10 may be implemented by the processor 91 reading and executing the program stored in the storage 93. Further, the above-described storage function of the leakage detection apparatus 10 may be implemented by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display apparatus 941, an input apparatus 942, a sound output apparatus 943, and the like. The display apparatus 941 is an apparatus such as a liquid crystal display (LCD), a cathode ray tube (CRT) display, or a monitor that displays a screen associated with rendering data processed by the processor 91. The input apparatus 942 is an apparatus that receives an operation input from an operator, and is, for example, a keyboard, a mouse, a touch sensor, or the like. The display apparatus 941 and the input apparatus 942 may be integrated and implemented as a touch panel. The sound output apparatus 943 is an apparatus, such as a speaker, that outputs sound associated with acoustic data processed by the processor 91.

The communication interface 95 transmits and receives data to and from an external apparatus. For example, the communication interface 95 communicates with an external apparatus via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A leakage detection apparatus including:
at least one memory storing instructions; and
at least one processor configured to execute the instructions to
   transmit pulsed light to an optical fiber laid in a pipe through which a fluid flows, and receive backscattered light from the optical fiber,
   generate sound data indicating a state of the fluid flowing through the pipe, based on the backscattered light, and
   detect leakage of the fluid by analyzing the sound data.

### (Supplementary Note 2)

The leakage detection apparatus according to supplementary note 1, wherein the at least one processor is further configured to execute the instructions to determine, in a case where leakage of the fluid is detected, a position where the leakage occurs.

### (Supplementary Note 3)

The leakage detection apparatus according to supplementary note 1, wherein the at least one processor is further configured to execute the instructions to:
calculate, in analysis of the sound data, a score rate associated with a deviation amount between a frequency component of the sound data and a frequency component of sound data at a normal state; and
detect leakage of the fluid, based on a temporal shift of the score rate.

### (Supplementary Note 4)

The leakage detection apparatus according to supplementary note 3, wherein the at least one processor is further configured to execute the instructions to:
hold a learning model being trained, in advance, with an association relationship between the temporal shift in the score rate and presence or absence of leakage of the fluid; and
detect leakage of the fluid, based on the temporal shift in the score rate and the learning model.

### (Supplementary Note 5)

The leakage detection apparatus according to supplementary note 1, wherein
the pipe includes an inner pipe through which a first fluid flows, and an outer pipe configured to cover the inner pipe with a gap and cause a second fluid to flow through the gap, and
the at least one processor is further configured to execute the instructions to analyze the sound data, thereby detect leakage of the first fluid from the inner pipe to the outer pipe, and also detect leakage of the second fluid from the outer pipe to the inner pipe.

### (Supplementary Note 6)

The leakage detection apparatus according to supplementary note 5, wherein
the pipe further includes a heat insulating material covering the outer pipe, and an exterior plate covering the heat insulating material, and
the optical fiber is laid between the heat insulating material and the exterior plate.

### (Supplementary Note 7)

The leakage detection apparatus according to supplementary note 5, wherein the first fluid is a liquid and the second fluid is a gas.

### (Supplementary Note 8)

A leakage detection method to be performed by a leakage detection apparatus, the leakage detection method including:
transmitting pulsed light to an optical fiber laid in a pipe through which a fluid flows, and receiving backscattered light from the optical fiber;
generating sound data indicating a state of the fluid flowing through the pipe, based on the backscattered light; and
detecting leakage of the fluid by analyzing the sound data.

### (Supplementary Note 9)

A non-transitory computer-readable medium storing a program causing a computer to execute:
a procedure of transmitting pulsed light to an optical fiber laid in a pipe through which a fluid flows, and receiving backscattered light from the optical fiber;
a procedure of generating sound data indicating a state of the fluid flowing through the pipe, based on the backscattered light; and
a procedure of detecting leakage of the fluid by analyzing the sound data.

### (Supplementary Note 10)

A leakage detection system including:
at least one memory storing instructions; and
at least one processor configured to execute the instructions to
   transmit pulsed light to an optical fiber laid in a pipe through which a fluid flows, and receive backscattered light from the optical fiber,
   generate sound data indicating a state of the fluid flowing through the pipe, based on the backscattered light, and
   detect leakage of the fluid by analyzing the sound data.

Note that, some or all of elements (e.g., structures and functions) specified in Supplementary Notes 2 to 7 dependent on Supplementary Note 1 may also be dependent on Supplementary Note 8, Supplementary Note 9 and Supplementary Note 10 in dependency similar to that of Supplementary Notes 2 to 7 dependent on Supplementary Note 1. Some or all of elements specified in any of Supplementary Notes may be applied to various types of hardware, software, and recording means for recording software, systems, and methods.

What is claimed is:

1. A leakage detection apparatus comprising:
at least one memory storing instructions; and
at least one processor configured to execute the instructions to
transmit pulsed light to an optical fiber laid in a pipe through which a fluid flows, and receive backscattered light from the optical fiber,
generate sound data indicating a state of the fluid flowing through the pipe, based on the backscattered light, and
detect leakage of the fluid by analyzing the sound data.

2. The leakage detection apparatus according to claim 1, wherein the at least one processor is further configured to execute the instructions to determine, in a case where leakage of the fluid is detected, a position where the leakage occurs.

3. The leakage detection apparatus according to claim 1, wherein the at least one processor is further configured to execute the instructions to:
calculate, in analysis of the sound data, a score rate associated with a deviation amount between a frequency component of the sound data and a frequency component of sound data at a normal state; and
detect leakage of the fluid, based on a temporal shift of the score rate.

4. The leakage detection apparatus according to claim 3, wherein the at least one processor is further configured to execute the instructions to:
hold a learning model being trained, in advance, with an association relationship between the temporal shift in the score rate and presence or absence of leakage of the fluid; and
detect leakage of the fluid, based on the temporal shift in the score rate and the learning model.

5. The leakage detection apparatus according to claim 1, wherein
the pipe includes an inner pipe through which a first fluid flows, and an outer pipe configured to cover the inner pipe with a gap and cause a second fluid to flow through the gap, and
the at least one processor is further configured to execute the instructions to analyze the sound data, thereby detect leakage of the first fluid from the inner pipe to the outer pipe, and also detect leakage of the second fluid from the outer pipe to the inner pipe.

6. The leakage detection apparatus according to claim 5, wherein
the pipe further includes a heat insulating material covering the outer pipe, and an exterior plate covering the heat insulating material, and
the optical fiber is laid between the heat insulating material and the exterior plate.

7. The leakage detection apparatus according to claim 5, wherein the first fluid is a liquid and the second fluid is a gas.

8. A leakage detection method to be performed by a leakage detection apparatus, the leakage detection method comprising:
transmitting pulsed light to an optical fiber laid in a pipe through which a fluid flows, and receiving backscattered light from the optical fiber;
generating sound data indicating a state of the fluid flowing through the pipe, based on the backscattered light; and
detecting leakage of the fluid by analyzing the sound data.

9. A non-transitory computer-readable medium storing a program causing a computer to execute:
a procedure of transmitting pulsed light to an optical fiber laid in a pipe through which a fluid flows, and receiving backscattered light from the optical fiber;
a procedure of generating sound data indicating a state of the fluid flowing through the pipe, based on the backscattered light; and
a procedure of detecting leakage of the fluid by analyzing the sound data.
